(19) United States
(12) Patent Application Publication
(10) Pub. No.: US 2015/0181046 A1
(43) Pub. Date: Jun. 25, 2015

(54) SECURE IN-APPLICATION AUTHENTICATION

(71) Applicant: NETSIZE, Meudon (FR)

(72) Inventors: Gregory Vigroux, La Ciotat (FR); Arnaud Dubreuil, La Ciotat (FR)

(21) Appl. No.: 14/408,880

(22) PCT Filed: Jun. 18, 2013
(86) PCT No.: PCT/EP2013/062636

§ 371 Date: Dec. 17, 2014

(30) Foreign Application Priority Data
Jun. 22, 2012 (EP) 12305720.0

(51) Int. Cl. H04M 15/00; H04M 1/725; G06Q 20/40; G06Q 20/32; H04W 12/06; H04W 4/14

(52) U.S. Cl. CPC H04M 15/48; H04W 12/06; H04W 4/14; G06Q 20/4014; G06Q 20/322; H04M 1/72522

(57) ABSTRACT

The present invention relates to a method to handle the authentication of a user of a device with an operator, said operator needing a user identifier for the purchase of additional element of an application installed in the device, said method implemented by a dedicated client component of the application. The invention also concerns an authentication server, a device and a software development kit to implement the method within an application in a device.

### FIELD OF THE INVENTION

The present invention relates to a method to handle the authentication of a user of a device with an operator, said operator needing a user identifier for the purchase of additional element of an application installed in the device. The invention also pertains to a device using said method.

### BACKGROUND OF THE INVENTION

The invention finds its use in context where an application was previously installed in a device: mobile phone, tablet . . . where it enables “in app” authentication. Such an authentication of end users is necessary to permit their billing on their mobile operator bill. This is generally the case for freemium application. Such applications are downloaded for free but user can purchase contents or services.

A known way of authentication of a user for Mobile Network Operator (MNO) is to receive SMS directly sent by the application.

Products were already launched using Android Software Development Kit (SDK) to perform authentication, opt-in and billing. This SDK is used by companies developing applications for in-app billing to monetize their freemium applications. Such SDKs authentication only uses Mobile Originating SMS. This solution is unsecure because it leads to security breach.

Indeed, when an application is authorized to send SMS, such messages can be sent anytime without any confirmation from the user. This leads to over-invoicing. Thus, Android's users do not wish to give this right to any application.

Moreover it brings fears to consumers. Indeed, in this case, before installing an additional element, the application asks the user for his authorization to send SMS. More precisely, when an end user installs on its Android handset/tablet an application using this SDK, the following warnings are displayed before installation:

“Network Communication full Internet access” if needed and more specifically:

“Services That Cost You Money: Send SMS Messages”

The last warning concerning mobile originated messages especially scares end users and few of them finally install this application. Transformation rate is very poor. Therefore such android SDKs are a commercial failure.

Moreover it occurs that the corresponding SDK is detected as a malware by antivirus. In fact, 85% of the malware corresponds to applications that send SMS to premium services and the client component is thus often assimilated to a virus.

### SUMMARY OF THE INVENTION

The present invention aims at avoiding the drawbacks of the prior art solutions in terms of security and in terms of conversion rate of additional element's requests. It aims in off-the-shelf solution to bring secure in-application billing through a non-intrusive authentication method.

The present invention concerns devices able to implement communication network connection to execute HTTP call. Such devices are for instance a mobile phone or a mobile device.

The present invention is defined, in its broadest sense, as a method of protecting a method to handle the authentication of a user of a device with an operator, said operator needing a user identifier for the purchase of additional element of an application installed in the device, said method implemented by a dedicated client component of the application comprising the following steps:

execution of an HTTP call from the application towards an authentication server,

if the HTTP call includes an user identifier, reception, by the authentication server, of the user identifier of the user in the HTTP call,

authentication of the user, by the authentication server, using the user identifier,

use, by the authentication server, of the user identifier with the operator in order to enable it to finalize the purchase using the user identifier.

An android SDK using the method of the invention would not have this issue. Indeed when an end user installs on its Android handset/tablet an application using a SDK based on this invention, the following warnings can be displayed: “Network Communication Full Internet Access”

“Your Messages: Receive SMS”

These warnings are not scary for an end user as they can be found in the majority of the applications on Android. Therefore transformation rate would be much higher. This invention clearly supersedes existing methods.

Indeed the invention is based on the fact that the first step of the authentication procedure is made through a HTTP call executed by the application to a hosted authentication server.

To make the invention useful, the authentication server needs to have a wide coverage of MNO authentication by HTTP call. The invention can be implemented on Android OS but is not limited to it. It can also be applied to other mobiles and tablets OS (Windows, Symbian, Bada, WebOS, . . . ).

Advantageously, the HTTP call going through a gateway of the mobile network operator, it comprises a step of injection of the user identifier to the authentication server.

Indeed, if the call is going through a MNO gateway, MNO will inject the user identifier to the authentication server that will catch it.

According to a particular implementation of the invention, the method includes a step of checking the availability of a user identifier in the HTTP call and, in the case no user identifier is available, implementing the following steps:

for the client component, asking the user for its phone number in an input field,

for the device, sending out the user's phone number in the HTTP call towards the authentication server,

for the authentication server, generating a secure token and, using the user's phone number, sending out a SMS to the user including the secure token,

for the user device, return of the secure token towards the authentication server after reception of said SMS.

Using a client component to ask the user for its phone number enables the authentication server to send an SMS towards the mobile phone without generating additional cost for the user. This implementation is particularly interesting when the HTTP call occurs via Wifi. In fact, in such a case, none identifier can be injected in the HTTP call contrarily to what occurs via 3G. The last warning “Your messages: receive SMS” is useful to enable the operation of this last feature where a mobile terminated SMS including secure token is received.

According to a particular feature, the method comprises, for the client component, a step of interception of the SMS and of extraction of the secure token from the SMS and a step of automatic return towards the authentication server.

With this feature, the client component is able to automatically process the content of the SMS without requiring any actions from the user. This concerns devices that include the application meanwhile being able to receive SMS, for instance, smartphones. The message is thus silent and non visible by the user.

According to another particular feature, the method comprises, for the client component, a step of asking for the secure token to be input manually by the user.

This feature concerns devices that are not able to intercept SMS. For example, a tablet will implement such a feature in collaboration with a mobile phone to receive SMS.

According to a fallback feature, the method comprises a step of checking the availability of a user identifier in the HTTP call and, in the case no user identifier is available, for the client component, implementing a step of sending out an SMS towards the authentication server including the user identifier.

This feature known from the state of the art enables to operate the in-application (in-app) billing in situations where none identifier is available in the HTTP call and when the previous solution using a secure token is not wished in particular application environment.

In an advantageous implementation, the method further comprises an opt-in step wherein a client component is opened on the device to ask for a confirmation of the purchase to the user and opt-in is received by the authentication server.

An opt-in step is legally compulsory in various countries. This feature enables to complete the billing process according to local laws.

Advantageously, the method also includes a billing step implemented once the authentication and, if required, the confirmation are completed.

This last step is the aim of the authentication as realized through the invention.

Advantageously, the billing step implements a Premium SMS billing or a direct billing.

The invention also concerns a software development kit intended to be used in the creation of applications intended to be installed on a user device, said development kit comprising a client component development sub-kit dedicated to the development of a client component to handle steps of the authentication method according to the invention.

Such a software development sub-kit would enable developers to easily insert a client component of the invention in any application software. The client component would generate HTTP calls according to the invention from the user device towards an authentication server of the invention. The user identifier will be received by the authentication server if such HTTP calls includes the user identifier. It is typically the case when said HTTP call is realized through a MNO a MNO network.

The invention also concerns authentication server able to handle the authentication of a user of a device with an operator, said operator needing an user identifier for the purchase of additional element of an application installed in the device, said authentication server comprising an HTTP communication link able to receive a user identifier through an HTTP call from the device, an SMS center, communication link with at least one operator and a server component for implementing the steps realized by the authentication server in the method of the invention.

Such a server includes a server component which can handle authentication and message sending according to the invention. It is also advantageously able to handle the opt-in receiving and billing.

It thus advantageously further comprises a billing server able to handle the invoicing of the user with several mobile network operators.

The invention also consists in a device including at least one application previously installed and susceptible to be supplemented with additional element and a dedicated client component adapted to the application environment, said client component being intended to handle the steps that are realized in the user's device in the authentication method of the invention with an operator needing a user identifier for the purchase of said additional element, said dedicated client component being able to trigger the execution of an HTTP call when a purchase is required by the user from the application towards an authentication server.

Such a device is able to implement every step of the method in collaboration with the server. If the HTTP call is realized through the MNO network, the user identifier is advantageously injected in the call.

According to a particular feature, said client component comprises a module to ask the user for his/her phone number and to send out the inputted phone number in the HTTP call towards the authentication server, if said identifier is not available in the HTTP call.

According to another particular feature, said client component comprises a module to handle the reception of an SMS and to return a secure token included in said SMS to the authentication server.

According to a particular feature, said client component comprises a module to send an SMS towards the authentication server including the user identifier if said identifier is not available in the HTTP call.

These three last particular features enable to implement the particular features of the method of the invention in any device according to the invention.

To the accomplishment of the foregoing and related ends, one or more embodiments comprise the features hereinafter fully described and particularly pointed out in the claims.

### BRIEF DESCRIPTION OF THE DRAWINGS

The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

FIG. 1 represents the environment wherein the invention is intended to be applied;

FIG. 2 shows a flowchart of the method of the invention;

FIG. 3 shows a flowchart of an optional step of the invention.

### DETAILED DESCRIPTION OF EMBODIMENTS OF THE INVENTION

The same elements have been designated with the same reference numerals in the different drawings. For clarity, only those elements and steps which are useful to the understanding of the present invention have been shown in the drawings and will be described. The mechanisms of data communication between the device and the server have not been detailed either, the present invention being compatible with usual mechanisms.

Moreover, when an action is said to be performed by a device, it is in fact executed by a microprocessor in this device controlled by instruction codes recorded in a program memory on the said device.

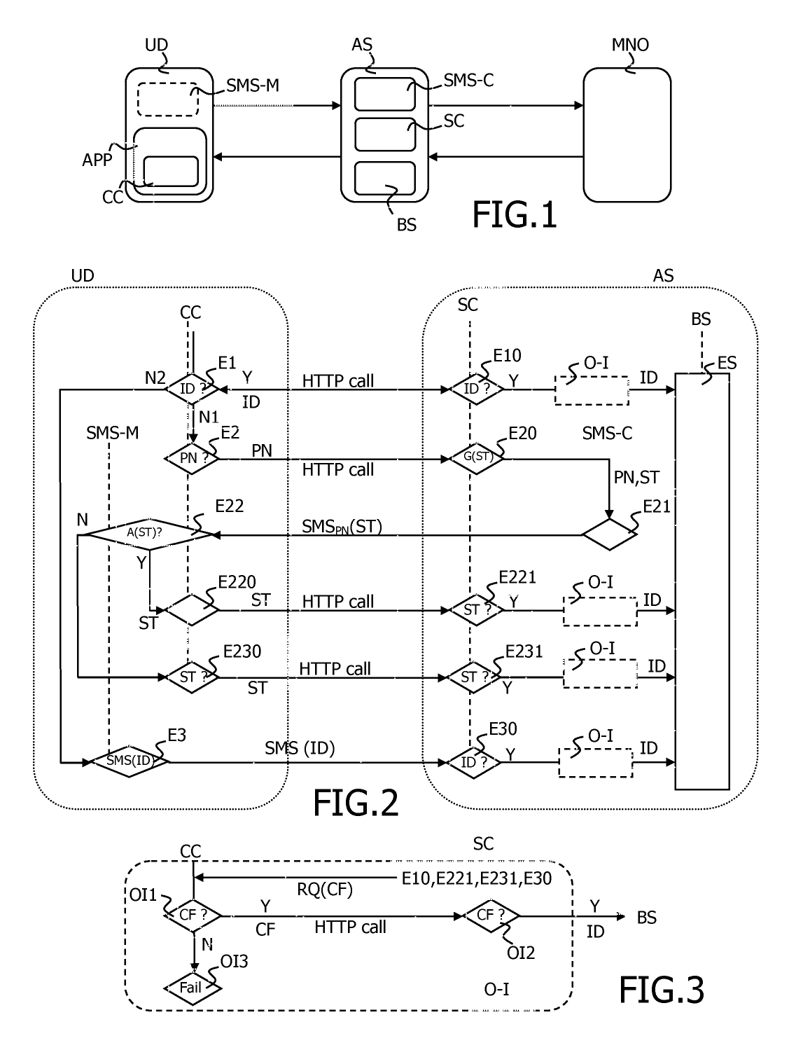

FIG. 1 schematically shows an environment wherein the invention is implemented. This environment comprises a user device UD, an authentication server AS and a mobile network operator MNO.

An application APP was previously installed in the user device UD. This application comprises a client component CC intended to implement steps of the invention in the user device. In the presented embodiment, it also advantageously comprises an integrated SMS module SMS-M. It will be seen that this SMS module SMS-M could instead be implemented in a separate device, typically a mobile phone while the user device UD is a tablet.

The authentication server AS comprises a server component SC intended to implement steps of the invention in the server. The authentication server also includes an SMS centre SMS-C and a billing server BS this billing server BS communicates with the mobile network operator MNO once the user is identified in order for the MNO to bill the user. Such communications can be realized through any wired or wireless connection.

The user device communicates with the server through a wireless connection emulated by the MNO and enabling HTTP calls. In order to implement the main step of the invention, HTTP calls need to include an identifier of the user. Such an identifier is automatically included in the communication when the HTTP call is realized via 3G. The invention particularly exploits this specific feature of 3G communication also known under the terms: HTTP enrichment. With this feature, the MNO injects the user identifier in the URL in any HTTP call (header MSDIM).

FIG. 2 shows a flowchart of the method of the invention. Steps of the invention are alternatively realized in the client component CC and the server component SC that are dedicated to the implementation of the invention respectively in the device UD and in the authentication server AS.

According to the invention, the client component CC initiates an HTTP call with the server client SC under command of the user. In a first step E1, the presence of a user identifier ID is checked. If the identifier ID is available (case Y), the identifier ID is extracted by the server component SC in a step E10. Then this identifier ID is send to the billing server BS that dialogs with the MNO to realize the billing of the user.

Then an opt-in step O-I is realized. It generally consists in a click from the end user. The opt-in can be completed with specific information if local laws require the user to be informed on specific sale conditions before any real billing.

FIG. 3 illustrates the functioning of such an opt-in step that is indeed realized by the client component CC under request RQ(CF) of confirmation CF from the user. The opt-in step can include the display of any required information needed by law to authorize a billing transaction. The request RQ(CF) is sent at the issue of any of steps E10, E221, E231 and E30 that will be explicitly described below.

Once the client component has received the request, it proceeds to a confirmation step OI1 where a purchase confirmation CF is asked to the user. If confirmation is given (case Y), it is sent through the HTTP call towards the server component SC that proceed to a step OI2 of sending of the identifier ID to the billing server for billing actions relative to the purchase of the additional element. This last step of sending the identifier ID is directly realized by any one of steps E10, E221, E231, E30 if no opt-in is required. The billing is mainly performed through SMS and direct billing.

In the case where none identifier is available in the HTTP call, a first fallback solution (case N1) consists in asking the user to enter manually his phone number PN on the client component CC in a step E2. The phone number PN is then transferred via the HTTP call to the server component SC that receives it. It triggers the generation G(ST) of a secure token ST in a step E20. The phone number PN and the secure token ST are then transferred to the SMS center SMS-C available in the authentication server. The SMS center SMS-C thus prepares and sends an SMS SMS_{PN}(ST) comprising the secure token ST to the phone number PN in a step E21.

The SMS is received by the SMS module SMS-M of the user device UD. In a preferred embodiment, the client component CC interferes with the SMS module SMS-M to automatically extract (A(ST)?) the secure token ST in a step E22. If the automatic extraction A(ST) is available (case Y), the extracted secure token ST is then returned by the client component CC via the HTTP call towards the server component SC in a step E220.

In a step E221, the server component checks if the returned secure token ST is identical to the previously sent one. If yes (case Y), the identifier ID is sent to the billing server BS, optionally after an opt-in step O-I as disclosed above. If the secure token ST is not available or is not identical (case not shown), a failure message is displayed on the user device UD.

In some embodiment, no automatic extraction A(ST) of the secure token is available (case N of step E22). It is the case if the client component is not able to do so or if the SMS module SMS-M that receives the SMS is on a device separated from the user device concerned by the additional element. Typically, it is the case when the SMS is received on the mobile phone of the user of a tablet connected through Wifi for the HTTP calls and on which an additional element is wished. This implementation (case N1), without automatic extraction, enables the user to pay through his mobile phone account. In this case, the SMS with the token ST is received on the mobile phone and purchase is confirmed on the tablet by entering the token on the tablet.

Thus, in this implementation, the client component asks the user for manually enter the secure token ST in a step E230. Once the secure token ST is entered by the user, it is returned to the server component that checks the identicity with the sent one in a step E231. Output of this last step is identical to the output of step E221.

Coming back to step E1, when no identifier ID is available in the HTTP call and the first fallback solution is not available (case N2), the SMS module SMS-M of the user device sends a SMS(ID) including the identifier ID of the user to the server component SC that extracts the identifier ID and send it to the billing server BS through the same process than after steps E10, E221 or E231. Such a mobile originating message is the second fallback solution according and is indeed already used on the market. Nevertheless it serves to handle any encountered situations. In this case, a warning concerning the sending of SMS by the application will be triggered with the previously explained drawbacks.

According to the application environment, different combination of the three authentication solutions can be used. The billing is triggered only if the authentication step and the opt-in, if necessary, are executed successfully. The MNO payment process is advantageously adapted depending on the price, the MNO and the application developer. It could be SMS billing, online billing, direct MNO billing platforms or any other solution proposed by MNO's to bill users.

The invention also consists in an off the shelf solution. This consists in a software development kit enabling to create a client component adapted to the application environment and able to carry on the steps of the method of the invention within the user device. It will bring secure in-application billing. The authentication processes handled by the invention are multiple and non-intrusive. A safe opt-in can be handled while multiple billing methods can be implemented following the authentication through the invention.

While simply using HTTP header enrichment provided by MNO in HTTP calls, the invention enables to bill end users for Pay-Per-Use or subscription in a secure way and with a high rate of conversion in terms of confirmed purchase.

Further alternative and advantageous solutions would, accordingly, be desirable in the art.

1. A method to handle the authentication of a user of a device with a mobile network operator, said operator needing a user identifier for the purchase of an additional element of an application installed in the device, said method implemented by a dedicated client component of the application, comprising:
executing an HTTP call from the application towards an authentication server,
if the HTTP call includes a user identifier, receiving, by the authentication server), the user identifier of the user in the HTTP call,
authenticating the user, by the authentication server, using the user identifier,
using, by the authentication server), the user identifier with the operator to enable the operator to finalize the purchase using the user identifier.

2. The method according to claim 1, wherein the HTTP call goes through a gateway of the mobile network operator, and further comprising injection by the mobile network operator of the user identifier to the authentication server.

3. The method according to claim 1, further comprising checking the availability of a user identifier in the HTTP call and, in the case no user identifier is available, implementing the following steps:
for the client component, asking the user for its phone number in an input field,
for the device, sending out the user's phone number in the HTTP call towards the authentication server,
for the authentication server), generating a secure token and, using the user's phone number, sending out a SMS message to the user including the secure token,
for the user device, returning the secure token to the authentication server after reception of said SMS message.

4. The method according to claim 3, comprising, for the client component, intercepting the SMS message, extracting the secure token from the SMS message, and automatically returning the secure token to the authentication server.

5. The method according to claim 3, comprising, for the client component, asking for the secure token to be input manually by the user.

6. The method according to claim 1, further comprising checking the availability of a user identifier in the HTTP call and, in the case no user identifier is available, for the client component, implementing a step of sending out an SMS message that includes the user identifier to the authentication server.

7. The method according to claim 1, further comprising an opt-in step wherein a client component is opened on the device to ask for a confirmation of the purchase to the user and wherein the confirmation is received by the authentication server.

8. The method according to claim 1, further comprising a billing step implemented once the authentication is completed.

9. The method according to claim 8, wherein the billing step implements a Premium SMS billing or a direct billing.

10. A software development kit to be used in the creation of applications to be installed on a user device, said development kit comprising a client component development sub-kit dedicated to the development of a client component to handle steps of the authentication method according to claim 1.

11. An authentication server configured to handle the authentication of a user of a device with a mobile network operator, said operator needing an user identifier for the purchase of an additional element of an application installed in the device, said authentication server comprising an HTTP communication link configured to receive a user identifier through an HTTP call from the device, an SMS center, a communication link with at least one operator and a server component for implementing the steps realized by the authentication server in the method of claim 1.

12. The authentication server according to claim 11, further comprising a billing server able to handle the invoicing of the user with several mobile network operators.

13. A device including at least one application previously installed and configured to be supplemented with an additional element, and a dedicated client component adapted to the application environment, said client component being configured to handle the steps that are realized in the user's device in the authentication method of claim 1 with an operator needing a user identifier for the purchase of said additional element, said dedicated client component being configured to trigger the execution of an HTTP call to an authentication server when a purchase is required by the user from the application.

14. The device according to claim 13, wherein said client component comprises a module to ask the user for the user's phone number and to send out the inputted phone number in the HTTP call towards the authentication server, if said identifier is not available in the HTTP call.

15. The device according to claim 13, wherein said client component comprises a module to handle the reception of an SMS message and to return a secure token included in said SMS message to the authentication server.

16. The device according to claim 13, wherein said client component comprises a module to send an SMS message to the authentication server including the user identifier if said identifier is not available in the HTTP call.
